(19) United States
(12) Patent Application Publication
(10) Pub. No.: US 2024/0242070 A1
(43) Pub. Date: Jul. 18, 2024

(54) Entity Classification Using Graph Neural Networks

(71) Applicant: International Business Machines Corporation, Armonk, NY (US)

(72) Inventors: Aniket Saxena, Ghaziabad (IN); Balaji Ganesan, Bengaluru (IN); Muhammed Abdul Majeed Ameen, Kozhikode (IN); Avirup Saha, Kolkata (IN); Arvind Agarwal, New Delhi (IN); Abhishek Seth, Deoband (IN); Soma Shekar Naganna, Bengaluru (IN)

(21) Appl. No.: 18/155,295

(22) Filed: Jan. 17, 2023

(51) Int. Cl. G06N 3/08

(52) U.S. Cl. CPC G06N 3/08

(57) ABSTRACT

A computer implemented method classifies records. A number of processor units creates a training dataset comprising subgraphs of matched records matched to an entity and identifying an importance of attributes in the matched records. The matched records in a subgraph are related to each other by a subset of the attributes. The number of processor units trains a graph neural network using the training dataset. The graph neural network classifies the records as belonging to the entity.

### BACKGROUND

The disclosure relates generally to an improved computer system and more specifically to a method, apparatus, computer system, and computer program product for performing entity classification.

In processing data, entity matching involves matching records to entities. For example, entity matching can involve identifying records that have the same real-world entity. Entity matching is also referred to as record linking, data matching, and entity resolution. This type of matching of records can be important in integrating records that originate from different sources. Data from different sources can have variations. For example, records from different sources can have variations in a term or name. Also, ambiguity can be present in the data in which the same term, phrase, or mention can have multiple meanings in addition to the entity.

For example, incoming records can be processed in batches to match the records to entities. Some techniques for matching in batches include bucketing and transitive linking. Graph neural networks (GNNs) have been used for entity matching.

### SUMMARY

According to one illustrative embodiment, a computer implemented method classifies records. A number of processor units creates a training dataset comprising subgraphs of matched records matched to an entity and the matched records having attributes. The matched records in a subgraph are related to each other by a subset of the attributes. The number of processor units trains a graph neural network using the training dataset. The graph neural network classifies the records as belonging to the entity. According to other illustrative embodiments, a computer system and a computer program product for classifying records are provided.

### BRIEF DESCRIPTION OF THE DRAWINGS

FIG. 1 is a block diagram of a computing environment in which illustrative embodiments can be implemented;

FIG. 2 is a block diagram of a data classification environment in accordance with an illustrative embodiment;

FIG. 3 is a block diagram illustrating data flow for training a graphic neural network to classify entities in accordance with an illustrative embodiment;

FIG. 4 is a graph of records for an entity in accordance with an illustrative embodiment;

FIG. 5 is a graph of records for an entity in accordance with an illustrative embodiment;

FIG. 6 is an illustration of subgraphs for use in training a graph neural network in accordance with an illustrative embodiment;

FIG. 7 is a flowchart of a process for classifying records in accordance with an illustrative embodiment;

FIG. 8 is a flowchart of a process for classifying records in accordance with an illustrative embodiment;

FIG. 9 is a flowchart of a process for classifying a record in accordance with an illustrative embodiment;

FIG. 10 is a flowchart of a process for creating a training dataset in accordance with an illustrative embodiment;

FIG. 11 is a flowchart of a process for training a graph neural network in accordance with an illustrative embodiment; and

FIG. 12 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

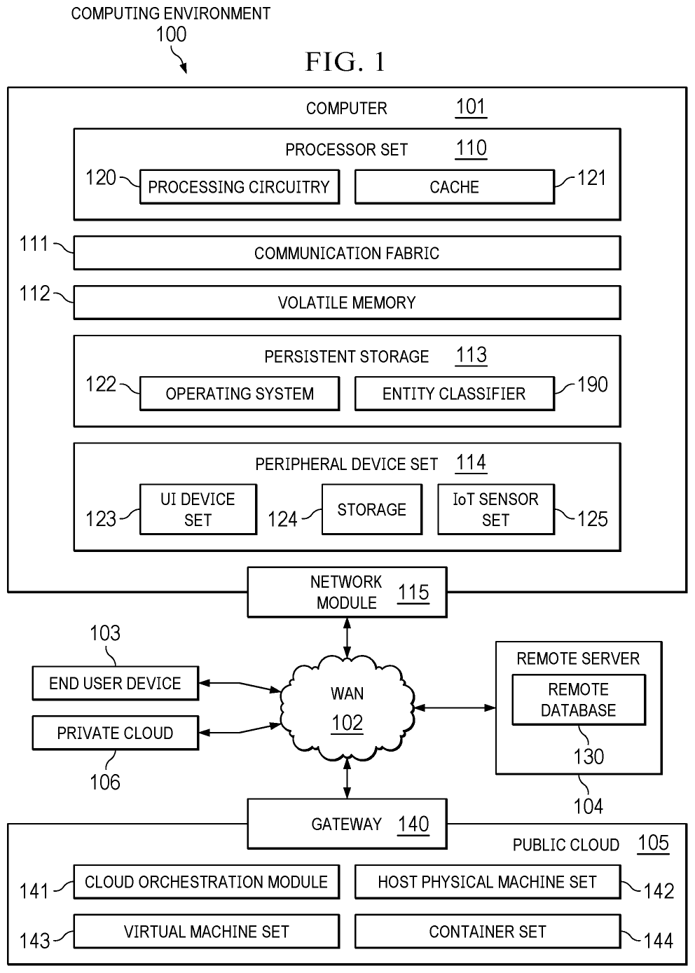

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as entity classifier 190. In addition to entity classifier 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and entity classifier 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in entity classifier 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in entity classifier 190 includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, entity matching has been performed as a batch problem. Determining whether a new record is linked to another record in the master data or belongs to an entity has been performed using bucketing and a pair wise entity matching. This type of system can be expensive and not as accurate as desired.

An alternative approach involves training the graph neural network model using master data such that a new record can be classified as belonging to an entity. The new record is a node to be added in the graph neural network as part of classifying the record. Existing entity matching systems, however, may not provide the desired level of accuracy using training data in the form of matched pairs.

Further, explaining why records are part of an entity can be difficult to perform with current techniques. Many types of entity matching algorithms do not attempt to explain the matching performed between records and entities. Thus, it would be desirable to have a method, apparatus, system, and computer program product that classifies records as belonging to entities in a manner that the matching can be explained.

Graphs of matched records currently used for training graph neural networks are simplistic and do not include real-world relationships. For example, current graphs have a representative node that can represent an entity with other nodes in which the edges indicate that those records are “same as”, which does not provide relationships between other nodes representing records in addition to the relationship to the representative node representing the entity.

In the illustrative examples, subgraph structures are generated from the graph structures to provide graph structures with differences that enable improved learning when used to train a graph neural network. This improved learning can result in improved accuracy in classifying records. The subgraphs in the illustrative examples can include different attributes such as address, phone number, location, store size, or other attributes in the records.

Thus, the illustrative embodiments provide a method, apparatus, system, and computer program product for classifying records. In one illustrative example, a graph neural network can be trained to classify records as belonging to an entity. A number of processor units creates a training dataset comprising subgraphs of matched records matched to an entity and the matched records having attributes. The matched records in a subgraph are related to each other by a subset of the attributes. The number of processor units trains a graph neural network using the training dataset. The graph neural network classifies the records as belonging to the entity.

Further, with the use of graph neural networks trained using subgraphs, these graph neural networks can classify a record as belonging to an entity. This type of classification is distinguished from current techniques which classify a record as a category such as fraud or not fraud.

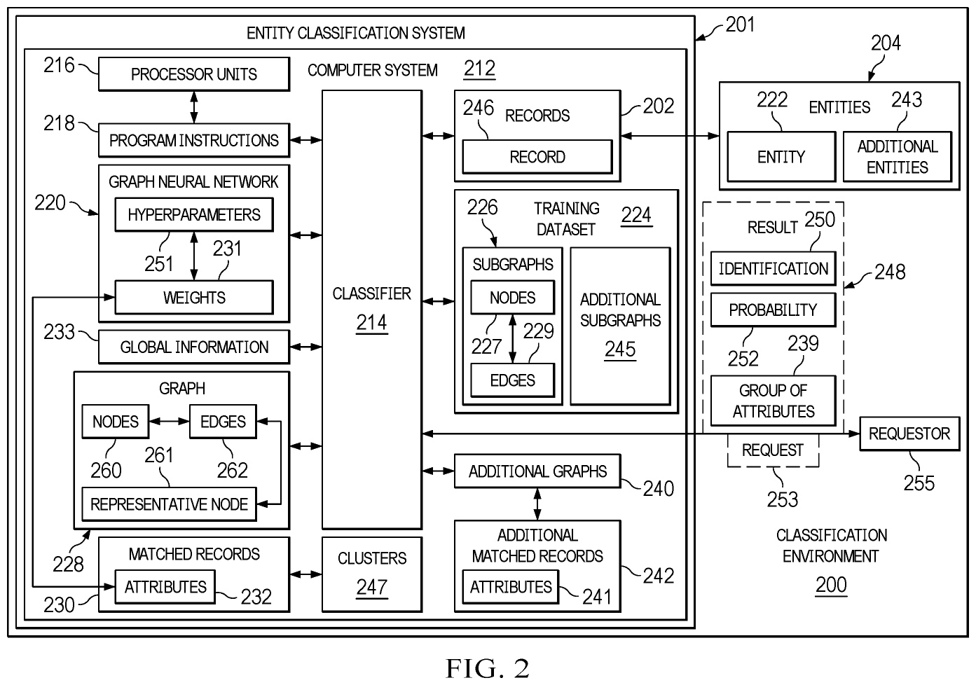

With reference now to FIG. 2, a block diagram of a data classification environment is depicted in accordance with an illustrative embodiment. In this illustrative example, classification environment 200 includes components that can be implemented in hardware such as the hardware shown in computing environment 100 in FIG. 1.

In classification environment 200, entity classification system 201 can operate to classify records 202 to entities 204. In this example, entity classification system 201 comprises computer system 212 and classifier 214. In this example, classifier 214 is located in computer system 212.

Classifier 214 can be implemented in software, hardware, firmware or a combination thereof. When software is used, the operations performed by classifier 214 can be implemented in program instructions configured to run on hardware, such as a processor unit. When firmware is used, the operations performed by classifier 214 can be implemented in program instructions and data and stored in persistent memory to run on a processor unit. When hardware is employed, the hardware can include circuits that operate to perform the operations in classifier 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program instructions that operate a computer. A processor unit can be implemented using processor set 110 in FIG. 1. When the number of processor units 216 executes program instructions 218 for a process, the number of processor units 216 can be one or more processor units that are on the same computer or on different computers. In other words, the process can be distributed between processor units 216 on the same or different computers in computer system 212. Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, classifier 214 can train graph neural network 220 to classify records 202 as belonging to entity 222 in a set of entities 204. As used herein, a “set of” when used with reference to items means one or more items. For example, a set of entities 204 is one or more of entities 204.

Classifier 214 creates training dataset 224 comprising subgraphs 226 of matched records 230 matched to entity 222. In this illustrative example, training data set 224 also includes graph 228 created from matched records 230 for entity 204. In this example, matched records 230 have attributes 232. In other illustrative examples, graph 228 can be omitted from training dataset 224.

As depicted, subgraphs 226 are comprised of a set of nodes 227 and edges 229. The set of nodes 227 represents a set of matched records 230. Edges 229 represent the relationships between the set of nodes 227.

In this example, graph 228 has nodes 260, representative node 261, and edges 262. Edges 262 connect nodes 260 to representative node 261. Nodes 260 are representations of matched records 230. Edges 262 in this graph can be all of the same type in which the edges indicate that the nodes are “same as” the representative node. Representative node 261 is a node for a matched record and is representative of entity 222 and nodes 260 represent matched records 230 for entity 222. In some illustrative examples, matched records 230 can be matched in pairs in which each pair has a score. This score can be used to add additional edges in edges 262 that connect nodes 260 to each other in graph 228.

In one illustrative example, subgraphs 226 can be created by classifier 214 using graph 228. Subgraphs 226 can be created by selecting subsets of attributes 232. The subsets of attributes 232 can be used to perform clustering on nodes 260 in graph 228 to generate subgraphs 226. In other words, the clustering to form a subgraph is performed using a subset of attributes 232 to cluster matched records 230 represented by nodes 260.

In another example, subgraphs 226 can be created by classifier 214 using matched records 230 directly. Classifier 214 can perform clustering on matched records 230 using the subsets of attributes 232 to form clusters 247. Each cluster in clusters 247 can have a different subset of attributes 232 used to cluster matched records 230. These clusters form subgraphs 226. Matched records 230 in a subgraph in subgraphs 226 are related to each other by a subset of attributes 232.

Thus, the creation of clusters 247 for subgraphs 226 can be performed by using graph 228 or matched records 230. In the illustrative examples, these subgraphs formed from clusters 247 are based on the selection of subsets of attributes 232.

Each subset of attributes 232 in subsets of attributes 232 can result in one or more subgraphs 226. The selection of subsets of attributes 232 can be made to provide different structures for the different subgraphs in subgraphs 226. This diversity in subgraphs 226 can increase the accuracy of graph neural network 220 when subgraphs 226 are used in training dataset 224 to train graph neural network 220.

In one illustrative example, a subset of attributes 232 in a cluster of matched records 230 can be, for example, area code and location. Further, the subset of attributes 232 includes values or ranges of values for attributes 232 in subset of attributes 232.

For example, an attribute used for clustering can be “phone number” and the value for this attribute can be “missing phone number” or “null value” for the attribute. In this example, classifier 214 can cluster matched records 230 for four stores from matched records for other stores. In this example, the four stores are missing the phone in matched records 230 for those four stores.

As another example, a subset of attributes 232 can be “city” in which the value for “city” is “New York”. In another example, a subset of attributes 232 can be a first attribute of “store type” that has a value of “hypermarket” and a second attribute that is “city” with a value that is “London”.

In this illustrative example, classifier 214 trains graph neural network 220 using training dataset 224. As result, the trained form of graph neural network 220 classifies records 202 as belonging to entity 222. This type of classification enables classifying record 246 as being a particular entity such as entity 222. This type of classification provides improvements over current techniques not using graph neural networks. Further, with this illustrative example, the accuracy in classifying record 246 is improved over current graph neural networks performing classifications through the use of subgraphs 226 in training dataset 224.

In addition to using training dataset 224 to train graph neural network 220, classifier 214 can also set weights 231 in the graph neural network 220 for attributes 232. In this illustrative example, weights 231 for attributes 232 used in training graph neural network 220 are hyperparameters 251. Hyperparameters 251 are parameters whose values control the learning process and determine the values of model parameters that a learning algorithm such as a graph neural network ends up learning.

These weights can identify the importance of attributes 232. In this example, weights 231 can be used to provide a level of importance for different attributes in attributes 232 in matched records 230 in subgraphs 226.

In this example, classifier 214 can select weights 231 for attributes 232 based on importance of attributes 232 in classifying records 202 as belonging to entity 222. For example, a greater weight can be given to attributes 232 for attributes in records 202 such as location, operating hours, and store size as compared the parking spaces.

These weights can be selected based on global information 233. Global information is information located outside of matched records 230 and provides information about real-world relationships. Global information 233 can provide context for records 202 and how records 202 are related to at least one of each other or entity 222. Those relationships can be used to select attributes 232 that are important in classifying records 202 and weights 231 can be selected for those attributes for training graph neural network 220.

In this example, global information 233 can include a set of global weights used in a legacy entity matching system that produces matched records 230 and graph 228. For example, the last 4 digits of social security number can be weighted higher than a zip code historically by requestor 255. These types of preferences on importance of attributes can be available from logs of previous runs of legacy entity matching system. As another example, global information 233 can be generated using the same algorithms run to find matches in attributes 232 by a legacy entity matching system. Examples of such algorithms include exact match, edit distance, cosine similarity, bucketing among others.

Further, the selection of weights 231 can change for different types of data sets. For example, a data set contains records for classifying entities 204 such as stores may have one set of weights 231. Weights 231 for another dataset containing records for classifying entities 204 such as banks can have a different set of weights 231 from weights 231 used for data set for stores. Thus, weights 231 for attributes 232 can change depending on the type of entity being classified.

After training graph neural network 220 using training dataset 224, classifier 214 can classify records 202 using graph neural network 220. For example, classifier 214 can receive request 253 from requestor 255 to classify record 246. Classifier 214 can input record 246 to graph neural network 220 trained using training dataset 224. In response, classifier 214 can receive result 248 of whether record 246 is classified as belonging to entity 222 from graph neural network 220. In this example, result 248 can be identification 250 of entity 222 and can include probability 252 that record 246 belongs to entity 222.

Result 248 is returned to requestor 255 in this example. Requestor 255 can be, for example, a human user, a program, a process, a modeling system, or other entity that can request classification of record 246.

Further, classifier 214 can return group of attributes 239 forming a basis for result 248. As used herein, a “group of” when used with reference items means one or more items. For example, group of attributes 239 is one or more attributes. Group of attributes 239 can be used as an explanation as to how the classification of record 246 was performed by graph neural network 220.

In this example, group of attributes 239 for result 248 can be determined in a number of different ways. For example, group of attributes 239 can be attributes 232 having weights 231 used in training graph neural network 220. Group of attributes 239 can also be a subset of attributes 232 given weights 231 for training graph neural network 220. As another example, group of attributes 239 can be some number of attributes 232 having the top values for weights 231. In other illustrative examples, a user can evaluate attributes 232 and determine which ones of attributes 232 should form group of attributes 239.

In another illustrative example, group of attributes 239 can be determined using a multilayer perception (MLP) model. A multilayer perception model can select different combinations of attributes 232 for classifying records and determine which attributes are important in which attributes are not important performing classifications. In these illustrative examples, when a MLP model is used, weights 231 for attributes 232 can be used as an input to the MLP model to help the MLP model more quickly select the group of attributes 239 that form the basis for result 248.

In this example, graph neural network 220 can be trained to classify record 246 for additional entities 243 in addition to or in place of entity 222. For example, additional graphs 240 can be created using matched records 230 for additional entities 243 in entities 204. Each of these additional graphs are created using additional matched records 242 having attributes 241 for the additional entities of interest in entities 204. Additional subgraphs 245 through clustering additional matched records 242 for additional graphs 240 for training dataset 224. With these additional subgraphs in training dataset 224, graph neural network 220 can be trained to classify records 202 and determine whether records 202 belong to entity 222 or additional entities 243.

In one illustrative example, one or more solutions are present that overcome a problem with accuracy in classifying records. In the illustrative examples, one or more solutions enable training a graph neural network to more accurately classify records as compared to current graph neural networks.

In one illustrative example, a training dataset is created that comprises subgraphs of matched records that have been matched to entity. The subgraphs are created in a manner that includes attributes in addition to an attributes saying that the record is the same as. In other words, the edges in the subgraphs are not all of “same as” type. Instead, the training dataset in the different illustrative examples can include other attributes of the records such as city, state, postal code, business name, telephone, entity ID, address, and other attributes for the entity.

Further, the subset of attributes can be selected for use in clustering records to create a set of subgraphs based on an importance of the attributes in determining whether a record can be classified as belonging to an entity. Thus, the training dataset created in the different illustrative examples can provide for increased accuracy in graph neural networks classifying records as belonging to a particular entity.

Computer system 212 can be configured to perform at least one of the steps, operations, or actions described in the different illustrative examples using software, hardware, firmware or a combination thereof. As a result, computer system 212 operates as a special purpose computer system in which classifier 214 in computer system 212 enables training graph neural networks to classify records with a greater accuracy as compared to current techniques for classifying or matching records. In one illustrative example, classifier 214 transforms computer system 212 into a special purpose computer system as compared to currently available general computer systems that do not have classifier 214.

In the illustrative example, the use of classifier 214 in computer system 212 integrates processes into a practical application for classifying records that increases the performance of computer system 212. In other words, classifier 214 in computer system 212 is directed to a practical application of processes integrated into classifier 214 in computer system 212 that trains a graph neural network in computer system 212 that provides a higher level of accuracy in classifying records.

The illustration of classification environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, training dataset 224 can also include graph 228 and additional graphs 240. In another illustrative example, one or more graph neural networks can be present in addition to graph neural network 220. These additional graph neural networks can be trained using training datasets comprising additional subgraphs 245 created from additional graphs 240 for additional entities 243. With this illustrative example, each graph neural network can be used to classifier records to determine whether those records belong to a particular entity.

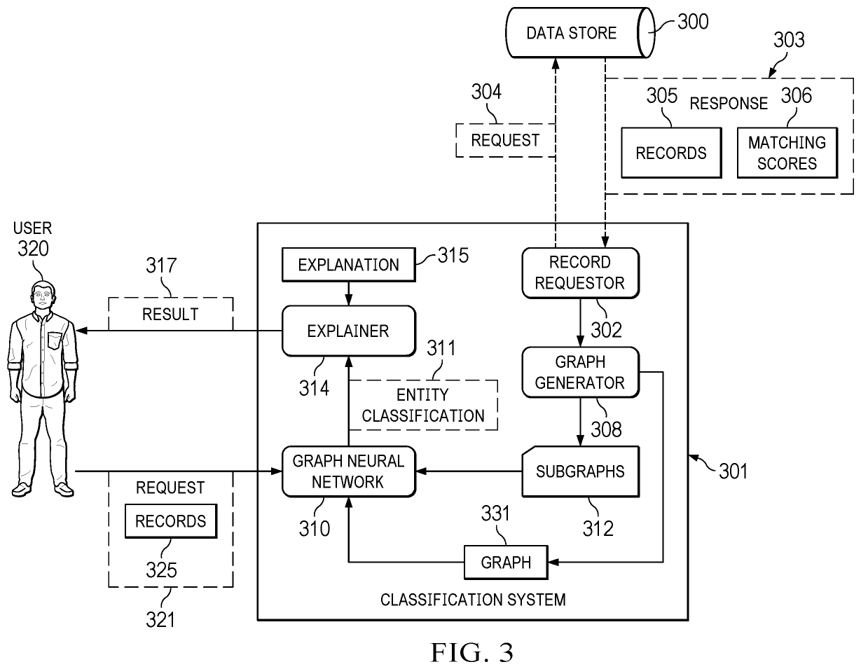

Turning next to FIG. 3, a block diagram illustrating data flow for training a graphic neural network to classify entities is depicted in accordance with an illustrative embodiment. In this illustrative example, a data store contains records for use in generating a training dataset. As depicted, record requester 302 in classification system 301 can send request 304 to data store 300 for records 305 for an entity. In this example, data store 300 returns response 303 with records 305 and matching scores 306 for records 305 have been compared to the entity.

The matching scores 306 indicate how close of pairs of records 305 match each other. In this illustrative example, graph generator 308 can generate graph 331 using records 305 and matching scores 306. Edges can connect nodes in graph 331 using matching scores 306. An edge can be present between two nodes if the matching score for the pair of records represented by the nodes is greater than a threshold value. In this example, graph 331 can have edges that are more than just nodes connected to a representative indicating that those nodes are the same as the entity identified in the representative.

Graph generator 308 performs clustering on records 305 based on attributes in records 305. In this example, graph generator 308 can perform clustering using graph 331. In other illustrative examples, the clustering can be performed on records 305 without using the representation of records 305 by the nodes in graph 331.

The clustering can be performed by graph generator 308 to identify clusters of records 305 from which subgraphs 312 are generated for an entity. Clustering can be performed using different subsets of attributes for records 305. Clustering using a subset of attributes can result in one or more subgraphs for that subset of attributes.

In this example, subgraphs 312 are used to train graph neural network 310 such that graph neural network 310 can classify records to determine whether the records belong to a particular entity. Further, graph 331 can also be used with subgraphs 312 to train graph neural network 310.

After training, user 320 can send request 321 to classify records 325. In this example, records 325 can be included in request 321. The actual records can be included as part of request 321 or a location of records 325 can be included in request 321.

In response to receiving request 321, graph neural network 310 can classify records 325 to generate entity classification 311. In this example, entity classification 311 indicates what entity the records belong to as a result of the classification performed on the records by graph neural network 310. Additionally, entity classification 311 can also include a probability that the classification made for a record is correct.

In this example, explainer 314 adds explanation 315 to entity classification 311. In this example, explanation 315 is an explanation of the basis for entity classification 311. For example, explanation 315 can be a list of attributes forming the basis of the classification, a weight or importance of the attributes, and other suitable information.

Explainer 314 returns result 317 containing explanation 315 and entity classification 311 to user 320. User 320 can review explanation 315 to determine what factors or basis was used that resulted in entity classification 311 of records 325.

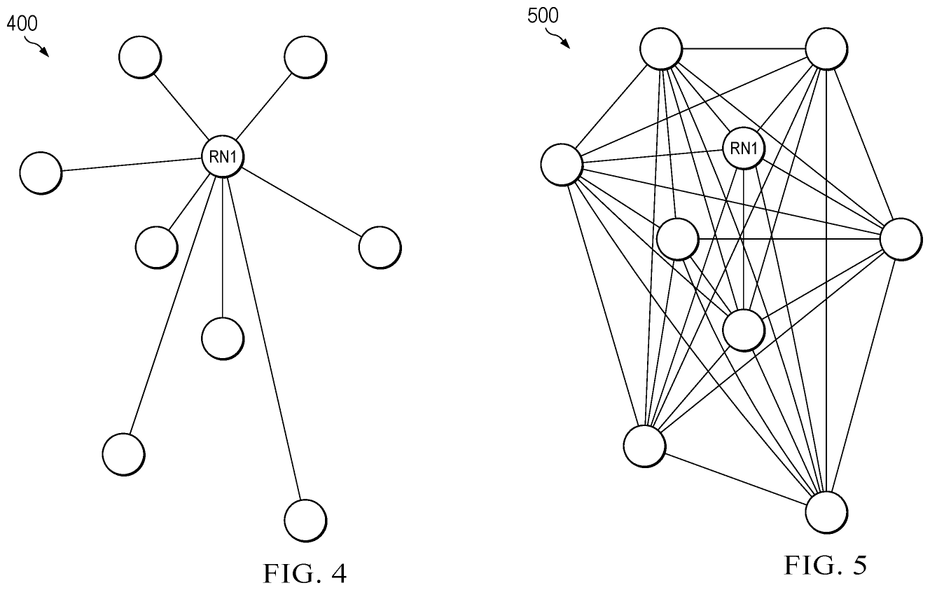

Turning to FIG. 4, a graph of records for entity is depicted in accordance with an illustrative embodiment. Graph 400 is an example of graph 228 in FIG. 2.

As depicted, graph 400 comprises nodes connected to representative node RN1 by edges. In this example, each node has the same relationship to representative node RN1. For example, each edge is “same as” to indicate that the nodes are the same as the entity represented by representative node RN1. As depicted, graph 400 does not provide as much information as may be desired to obtain a desired level accuracy for training a graph neural network without additional information.

Next, FIG. 5 is a graph of records for an entity in accordance with an illustrative embodiment. Graph 500 is an example of graph 228 in FIG. 2.

In this illustrative example, graph 500 comprises nodes connected to representative RN1 by edges. The nodes are also connected to each other by edges. These additional connections can be determined based on pairwise scores for pairs of records. In other words, when two records have a pairwise score above the threshold, an edge can be created between nodes for those two records when those two records are present in graph 500. The edges can be “same as” with the nodes all having the same relationship with every other node. Graph 500 can also be used in training a graph neural network.

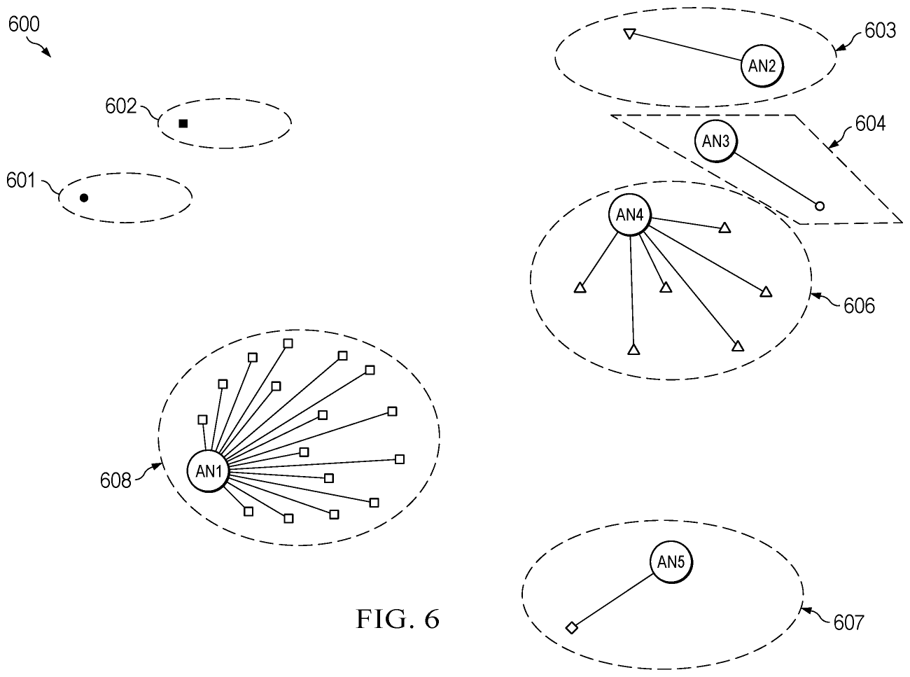

With reference now to FIG. 6, an illustration of subgraphs for use in training a graph neural network is depicted in accordance with an illustrative embodiment. Subgraphs 600 are examples of subgraphs 226 in FIG. 2.

In this illustrative example, subgraphs 600 includes subgraph 601, subgraph 602, subgraph 603, subgraph 604, subgraph 606, subgraph 607, and subgraph 608. As depicted, subgraphs 600 are the result of clustering records using a single subset of attributes. In other words, when a subset of attributes is selected for clustering records, one or more subgraphs can be generated from that subset of attributes for the records.

In this example, subgraph 608 has representative node AN1 connected to nodes in subgraph 608 and subgraph 606 has representative node AN2 connected to nodes. Subgraph 603 has representative node AN2 connected to a node by an edge; subgraph 604 has representative node AN3 connected to a node by an edge; subgraph 607 has representative node AN5 connected to a node by an edge.

As depicted, subgraph 601 and subgraph 602 each a single node. These single nodes are the representative nodes for these two subgraphs.

The illustration of graphs and subgraphs in FIGS. 4-6 are provided as simplified examples of graphs and subgraphs that can be used as training data to train graph neural networks. These illustrations are examples and not intended to limit the manner in which the illustrative examples can be implemented.

For example, actual graphs and in subgraphs can have hundreds or thousands of nodes. Further, in other illustrative examples, the selection of a subset of attributes may only result in the generation of a single subgraph. In yet other illustrative examples, the selection of the subset of attributes can result in 2 subgraphs, 14 subgraphs, or some other number of subgraphs being created from clustering records using the selected subset of attributes.

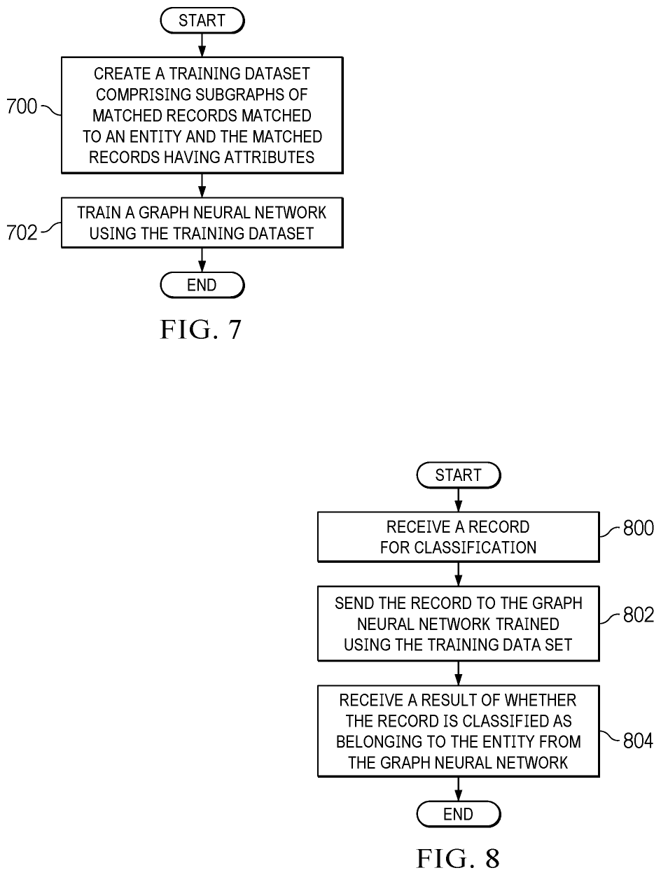

Turning next to FIG. 7, a flowchart of a process for classifying records is depicted in accordance with an illustrative embodiment. The process in FIG. 7 can be implemented in hardware, software, or both. When implemented in software, the process can take the form of program instructions that are run by one of more processor units located in one or more hardware devices in one or more computer systems. For example, the process can be implemented in classifier 214 in computer system 212 in FIG. 2.

The process begins by creating a training dataset comprising subgraphs of matched records matched to an entity and the matched records having attributes (step 700). In step 700, the matched records in a subgraph are related to each other by a subset of attributes.

The process trains a graph neural network using the training dataset (step 702). The process terminates thereafter. In step 702, the graph neural network classifies the records indicating whether the records belong to the entity.

With reference next to FIG. 8, a flowchart of a process for classifying records is depicted in accordance with an illustrative embodiment. The process illustrated in FIG. 8 is an example of additional steps that can be performed with the steps in FIG. 7. In this example, these steps are an illustration of a process for classifying a record using the trained graph neural network.

The process begins by receiving a record for classification (step 800). The process sends the record to the graph neural network trained using the training dataset (step 802).

The process receives a result of whether the record is classified as belonging to the entity from the graph neural network (step 804). The process terminates thereafter. In this example, the result can indicate that the record belongs to the entity or that the record does not belong to the entity. Additionally, the result can also include a probability that the classification of the record is correct.

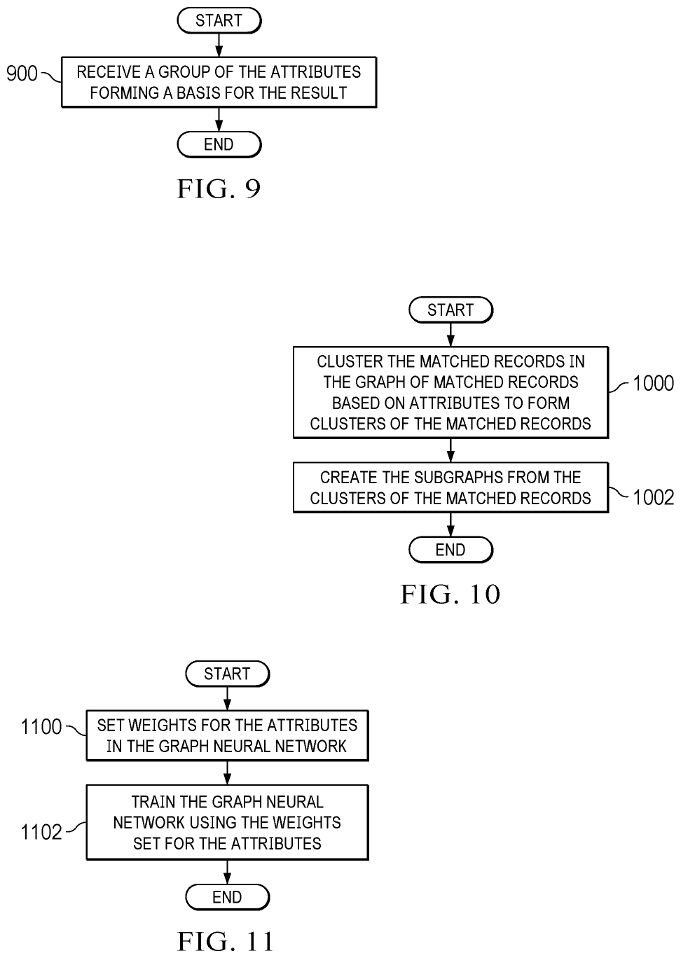

In FIG. 9, a flowchart of a process for classifying a record is depicted in accordance with an illustrative embodiment. The process illustrated in this figure is an example of an additional step that can be performed in addition to the steps illustrated in FIG. 8.

The process receives a group of the attributes forming a basis for the result (step 900). The process terminates thereafter. The group of attributes is used as an explanation of the results of the classification of the record.

Turning to FIG. 10, a flowchart of a process for creating a training dataset is depicted in accordance with an illustrative embodiment. The process in FIG. 9 is an example of an implementation for step 700 in FIG. 7. In this example, clustering is performed on a graph of the matched records for an entity.

The process begins by clustering the matched records in the graph of matched records based on attributes to form clusters of the matched records (step 1000). In step 1000, the matched records in a subgraph are related to each other by a subset of the attributes. In this illustrative example, the clustering process can receive attributes of interest for a particular subgraph in performing clustering of records.

The process creates the subgraphs from the clusters of the matched records (step 1002). The process terminates thereafter. In this example, the subgraphs created using this process form the training dataset. In some illustrative examples, a graph of the matched records can also be used as part of the training dataset.

In another illustrative example, the clustering process used in FIG. 10 can be performed using the matched records for the entity without the graph of the matched records.

With reference now to FIG. 11, a flowchart of a process for training a graph neural network is depicted in accordance with an illustrative embodiment. The process illustrated in FIG. 11 is an example of an implementation for step 702 in FIG. 7.

The process begins by setting weights for the attributes in the graph neural network (step 1100). In step 1100, the weights are selected based on importance of the attributes in classifying records as belonging to the entity. This selection of weights can be made using global information from external sources outside of information found in matched records or records that have been processed for training the graph neural network.

The process trains the graph neural network using the weights set for the attributes (step 1102). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

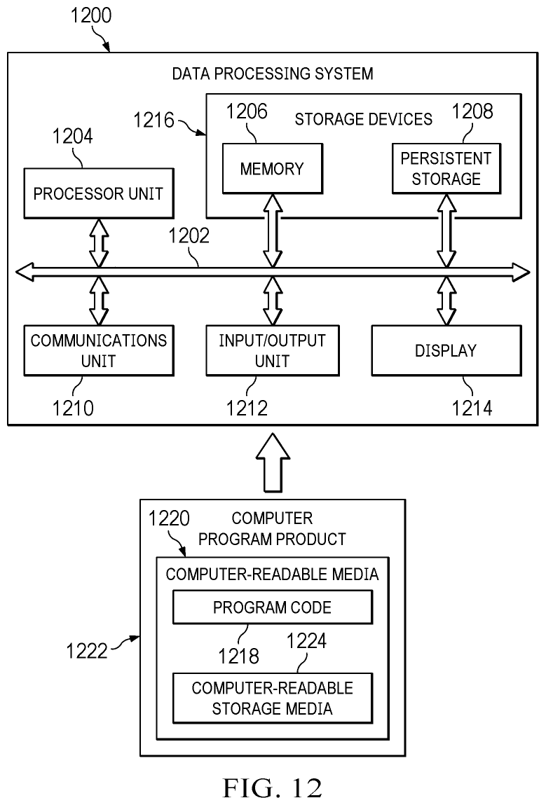

Turning now to FIG. 12, a block diagram of a data processing system is depicted in accordance with an illustrative embodiment. Data processing system 1200 can be used to implement computers and computing devices in computing environment 100 in FIG. 1. Data processing system 1200 can also be used to implement computer system 212 in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can may be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1216 may also be referred to as computer readable storage devices in these illustrative examples. Memory 1206, in these examples, can be, for example, a random-access memory or any other suitable volatile or non-volatile storage device. Persistent storage 1208 may take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 may provide a connection for user input through at least one of a keyboard, a mouse, or some other suitable input device. Further, input/output unit 1212 may send output to a printer. Display 1214 provides a mechanism to display information to a user.

Instructions for at least one of the operating system, applications, or programs can be located in storage devices 1216, which are in communication with processor unit 1204 through communications framework 1202. The processes of the different embodiments can be performed by processor unit 1204 using computer-implemented instructions, which may be located in a memory, such as memory 1206.

These instructions are referred to as program instructions, computer usable program instructions, or computer readable program instructions that can be read and executed by a processor in processor unit 1204. The program instructions in the different embodiments can be embodied on different physical or computer readable storage media, such as memory 1206 or persistent storage 1208.

Program instructions 1218 is located in a functional form on computer readable media 1220 that is selectively removable and can be loaded onto or transferred to data processing system 1200 for execution by processor unit 1204. Program instructions 1218 and computer readable media 1220 form computer program product 1222 in these illustrative examples. In the illustrative example, computer readable media 1220 is computer readable storage media 1224.

Computer readable storage media 1224 is a physical or tangible storage device used to store program instructions 1218 rather than a medium that propagates or transmits program instructions 1218. Computer readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1218 can be transferred to data processing system 1200 using a computer readable signal media. The computer readable signal media are signals and can be, for example, a propagated data signal containing program instructions 1218. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1220” can be singular or plural. For example, program instructions 1218 can be located in computer readable media 1220 in the form of a single storage device or system. In another example, program instructions 1218 can be located in computer readable media 1220 that is distributed in multiple data processing systems. In other words, some instructions in program instructions 1218 can be located in one data processing system while other instructions in program instructions 1218 can be located in one data processing system. For example, a portion of program instructions 1218 can be located in computer readable media 1220 in a server computer while another portion of program instructions 1218 can be located in computer readable media 1220 located in a set of client computers.

The different components illustrated for data processing system 1200 are not meant to provide architectural limitations to the manner in which different embodiments can be implemented. In some illustrative examples, one or more of the components may be incorporated in or otherwise form a portion of, another component. For example, memory 1206, or portions thereof, may be incorporated in processor unit 1204 in some illustrative examples. The different illustrative embodiments can be implemented in a data processing system including components in addition to or in place of those illustrated for data processing system 1200. Other components shown in FIG. 12 can be varied from the illustrative examples shown. The different embodiments can be implemented using any hardware device or system capable of running program instructions 1218.

Thus, illustrative embodiments of the present invention provide a computer implemented method, computer system, and computer program product for classifying records. In one illustrative example, a computer implemented method classifies records. A number of processor units creates a training dataset comprising subgraphs of matched records matched to an entity and the matched records having attributes. The matched records in a subgraph are related to each other by a subset of the attributes. The number of processor units trains a graph neural network using the training dataset. The graph neural network classifies the records as belonging to the entity.

In one illustrative example, a graph neural network can be trained to classify records with increased accuracy as compared to current graph neural networks. In an illustrative example, a training dataset is created that comprises subgraphs of matched records that have been matched to entity. The subgraphs can be created in a manner that includes attributes in addition to an attribute indicating that the record is the “same as”. A subset of attributes can be selected for clustering to create a subgraph based on an importance of the attributes in determining whether a record can be classified as belonging to an entity. Thus, the training dataset created in the different illustrative examples can provide increased performance in graph neural networks classifying records.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for classifying records, the computer implemented method comprising:
creating, by a number of processor units, a training dataset comprising subgraphs of matched records matched to an entity and the matched records having attributes, wherein the matched records in a subgraph are related to each other by a subset of the attributes; and
training, by the number of processor units, a graph neural network using the training dataset, wherein the graph neural network classifies the records indicating whether the records belong to the entity.

2. The computer implemented method of claim 1 further comprising:
receiving, by the number of processor units, a record for classification;
sending, by the number of processor units, the record to the graph neural network trained using the training dataset; and
receiving, by the number of processor units, a result of whether the record is classified as belonging to the entity from the graph neural network.

3. The computer implemented method of claim 2 further comprising:
receiving, by the number of processor units, a group of the attributes forming a basis for the result.

4. The computer implemented method of claim 1, wherein creating, by the number processor units, the training dataset comprising the subgraphs of the matched records matched to the entity and having the attributes, wherein the matched records in a subgraph are related to each other by the subset of the attributes comprises:
clustering, by the number of processor units, the matched records in a graph of matched records based on attributes to form clusters of the matched records, wherein the matched records in a subgraph are related to each other by a subset of the attributes; and
creating, by the number of processor units, the subgraphs from the clusters of the matched records, wherein the subgraphs form the training dataset.

5. The computer implemented method of claim 4, wherein the training dataset further comprises the graph of matched records.

6. The computer implemented method of claim 1, wherein training, by the number of processor units, the graph neural network using the training dataset comprises:
setting, by the number of processor units, weights for the attributes in the graph neural network; and
training, by the number of processor units, the graph neural network using the weights set for the attributes.

7. The computer implemented method of claim 6, wherein the weights are selected based on importance of the attributes in classifying records as belonging to the entity.

8. A computer system comprising:
a number of processor units, wherein the number of processor units executes program instructions to:
create a training dataset comprising subgraphs of matched records matched to an entity and the matched records having attributes, wherein the matched records in a subgraph are related to each other by a subset of the attributes; and
train a graph neural network using the training dataset, wherein the graph neural network classifies the records indicating whether the records belong to the entity.

9. The computer system of claim 8, wherein the number of processor units executes the program instructions to:
receive a record for classification;
send the record to the graph neural network trained using the training dataset; and
receive a result of whether the record is classified as belonging to the entity from the graph neural network.

10. The computer system of claim 9, wherein the number of processor units executes the program instructions to:
receive a group of the attributes forming a basis for the result.

11. The computer system of claim 8, wherein in creating the training dataset comprising the subgraphs of the matched records matched to the entity and having the attributes, wherein the matched records in a subgraph are related to each other by the subset of the attributes, the number of processor units executes the program instructions to:
cluster the matched records in a graph of matched records based on attributes to form clusters of the matched records, wherein the matched records in a subgraph are related to each other by a subset of the attributes; and
create the subgraphs from the clusters of the matched records, wherein the subgraphs form the training dataset.

12. The computer system of claim 11, wherein the training dataset further comprises the graph of matched records.

13. The computer system of claim 9, wherein in training the graph neural network using the training dataset, the number of processor units executes the program instructions to:
set weights for the attributes in the graph neural network; and
train the graph neural network using the weights set for the attributes.

14. The computer system of claim 13, wherein the weights are selected based on importance of the attributes in classifying records as belonging to the entity.

15. A computer program product for matching records, the computer program product comprising a computer readable storage medium having program instructions embodied therewith, the program instructions executable by a computer system to cause the computer system to perform a method of:
creating, by a number of processor units, a training dataset comprising subgraphs of matched records matched to an entity and the matched records having attributes, wherein the matched records in a subgraph are related to each other by a subset of the attributes; and
training, by the number of processor units, a graph neural network using the training dataset, wherein the graph neural network classifies the records indicating whether the records belong to the entity.

16. The computer program product of claim 15 further comprising:
receiving, by the number of processor units, a record for classification;
sending, by the number of processor units, the record to the graph neural network trained using the training dataset; and
receiving, by the number of processor units, a result of whether the record is classified as belonging to the entity from the graph neural network.

17. The computer program product of claim 16 further comprising:
receiving, by the number of processor units, a group of the attributes forming a basis for the result.

18. The computer program product of claim 15, wherein creating, by the number of processor units, the training dataset comprising the subgraphs of the matched records matched to the entity and having the attributes, wherein the matched records in a subgraph are related to each other by the subset of the attributes comprises:
clustering, by the number of processor units, the matched records in a graph of matched records based on attributes to form clusters of the matched records, wherein the matched records in a subgraph are related to each other by a subset of the attributes; and
creating, by the number of processor units, the subgraphs from the clusters of the matched records, wherein the subgraphs form the training dataset.

19. The computer program product of claim 18, wherein the training dataset further comprises the graph of matched records.

20. The computer program product of claim 15, wherein training, by the number of processor units, the graph neural network using the training dataset comprises:
setting, by the number of processor units, weights for the attributes in the graph neural network; and
training, by the number of processor units, the graph neural network using the weights set for the attributes.
